(19) United States
(12) Patent Application Publication
(10) Pub. No.: US 2013/0307335 A1
(43) Pub. Date: Nov. 21, 2013

(54) DEVICE AND METHOD FOR CHANGING A POWER CONSUMPTION PROFILE OF AT LEAST ONE PERSON IN A HOUSE OR A RESIDENTIAL UNIT HAVING A DISTRIBUTION NETWORK

(71) Applicant: Johanna May, Ludwigsburg (DE)

(72) Inventor: Johanna May, Ludwigsburg (DE)

(73) Assignee: ROBERT BOSCH GMBH, Stuttgart (DE)

(21) Appl. No.: 13/899,162

(22) Filed: May 21, 2013

(30) Foreign Application Priority Data
May 21, 2012 (DE) 10 2012 208 415.0

(51) Int. Cl. H02J 4/00

(52) U.S. Cl. CPC H02J 4/00
USPC 307/31

(57) ABSTRACT

A device for changing a power consumption profile of at least one person in a house or a residential unit having a distribution network, the device having: an electrical storage mechanism designed to store electrical energy, a power switching device that is connected to the electrical energy storage mechanism and the distribution network, and which is designed to switch on and off an electric energy flow between the electrical energy storage mechanism and the distribution network, and a control device, which is designed to control the electrical energy flow with the aid of at least one variable criterion and thereby to change the power consumption profile of the distribution network.

### CROSS REFERENCE

The present application claims the benefit under 35 U.S.C. §119 of German Patent Application No. DE 102012208415.0, filed on May 21, 2012, which is expressly incorporated herein by reference in its entirety.

### FIELD

The present invention relates to a device and method for changing a power consumption profile of at least one person in a house or a residential unit having a distribution network.

### BACKGROUND INFORMATION

German Patent Application No. DE 20 2011 004 327 U1 describes a communications module for reading out counter values from electronic counters, which is either mounted on the counter or externally, wherein this communications module fulfills the functions data interrogation, data collection and data transmission, the last of these not having to be initiated externally but is able to be controlled dynamically from the outside, and in addition, it has a chip, via which the counter values are transmitted without external initiation.

The module described there has at least one microprocessor and at least one storage unit and a power supply which are later able to be simply connected, and which extend the functionality of the counter.

German Patent Application No. DE 10 2010 027 171 A1 describes a method for representing data on the power consumption of a user with regard to a flexible, cost-effective way of representing the data that is implementable at low cost.

The method described there includes the steps: reading out an electronic supply meter at the user for ascertaining data on the power supply, transmitting the data to a server, displaying the received data on a television unit connected to the unit.

Most households in many countries are equipped these days with so-called conventional household counters that have no communications interface at all to the power supplier. This is supposed to change in the near future in the European Community and in other areas of the world: So-called intelligent counters, also called smart meters, are supposed to be introduced. Intelligent counters are counters for energy, such as electric current or gas, which indicate to the respectively connected user the actual energy consumption and the actual time of consumption. Counters are also designated as smart meters or intelligent counters if they are at least controlled by one microprocessor.

The purpose of intelligent counters is to provide all end users in the areas of electric current, natural gas, remote heating and hot water with a display facility, at competitively oriented prices, which reflects the actual energy use of the end user and the actual time of use in private households. So-called smart meters, which transmit the user data of the household via a communications interface in “real time”, i.e., approximately hourly, offer the possibility to the energy suppliers and the network operators of undertaking requirement-controlled regulation in the network, such as switching on and off users by signals, in order to demand more or less power from power plants.

Man-in-the-middle attacks, also middle-man attacks or Janus attacks or other forms of attack on computer networks which are processing consumer information and particularly electric current consumption data would give the attacker the possibility of making possible the drawing of conclusions on the presence of the power customer in his home.

Consequently, smart metering also represents a security risk with regard to data protection for households. On the one hand, there is the danger that the data may fall into the wrong hands, so that, for example, theft gangs are able to see, based on the absence of the residents of a home, that theft will particularly pay off, as, for example, at vacation times in residential areas, without observing the object directly. On the other hand, it is possible to determine, by the analysis of finely resolved current use profiles, which activities a user has just engaged in or is just engaging in, so that it may be determined, for instance, using the bright/dark intensity of the different TV programs in the current consumption profile which TV program is currently playing on the TV set.

### SUMMARY

The present invention provides an example device and method for simulating the presence of at least one person in a house or a residential unit, using a distribution network.

Accordingly, the present invention provides an example for changing a power consumption profile of at least one person in a house or a residential unit using a distribution network.

The device includes an electrical storage mechanism designed to store electrical energy, a power switching device that is connected to the electrical energy storage mechanism and the distribution network, and which is designed to switch on and off an electric energy flow between the electrical energy storage mechanism and the distribution network; and a control device, which is designed to control the electrical energy flow with the aid of at least one variable criterion and thereby to change the power consumption profile of the distribution network.

Moreover, according to the present invention, an example method for changing a power consumption profile of at least one person in a house or a residential unit having a distribution network is provided including providing at least one variable criterion for changing the power consumption profile of the distribution network by a control device, and providing an electrical energy storage mechanism, controlling an electrical energy flow with the aid of the at least one variable criterion by activating a power switching device by the control device, in order to switch on and off the electrical energy flow between the electrical energy storage mechanism and the distribution network; and changing the power consumption profile of the distribution network.

In accordance with the present invention, a house battery system, connected to the distribution network, in the form of an electrical energy storage, is used to change or falsify the power requirement profile. In the simplest case, the battery is a battery which is connected to the distribution network using an inverter and via a control device.

In addition, a user interface such as a display or a computer screen is required on a system server, into which the user is able to enter when the system is to be active.

As a switched-off security system, the battery system of the device is only able to be used for its originally provided tasks, as a backup system in the case of current failure or for optimizing self-use of self-generated current from photovoltaic systems, combined heat and power coupling or small wind systems or small water power systems or local biomass power generation systems.

For theft prevention, in the absence of the residents, the device charges the battery connected to the device from time to time, or discharges it, so as to simulate a presence at the intelligent counter. It is useful if the system has access to users connected to the distribution network, such as room light, outside light, stereo system, TV, air conditioning system or other users which permit discharging the battery of the device more greatly, and also simulating a presence by additional signals (light, noises). In addition, the battery may also be discharged into the distribution network and/or into the power network or be charged by the distribution network.

To protect the private sphere, in the presence of the residents, the battery of the house battery system connected to the distribution network may be charged or discharged, in order to simulate other than the load profile actually taking place.

In addition, a control device is designed in such a way that the control device charges and/or discharges the battery, controlled by chance, via the distribution network and or the power net. In addition, the control device is particularly designed in such a way that the control device switches on or off, under random control, users connected to the distribution network.

According to one further advantageous specific embodiment of the present invention, it is provided that the control device of the device is also connected to an interfacial device, and the control device is designed to set the at least one variable criterion by inputs of a user actuated via the interfacial device. This advantageously makes it possible to send the user an interactive feedback on the operating state. The at least one criterion is, for instance, a parameter of the chance control and/or a minimum switch-in duration of a user and/or a user.

According to one advantageous specific embodiment of the present invention, it is provided that the control device is further designed to display to the consumer data on an operating state of the device and/or data on the current electrical energy flow via the interface device connected to the control device.

According to one further advantageous specific embodiment, it is provided that the control device of the device is further connected to a sensor device and the control device is designed to ascertain the presence of the person based on data recorded by the sensor device. This makes it possible effectively to activate the device only if no person is currently staying in the house.

According to one further advantageous specific embodiment of the present invention, it is provided that the device is also connected to additional users of the distribution network, so as to discharge the electrical energy storage mechanism. Thereby an efficient and energy-saving operation of the device is achieved.

According to another advantageous specific embodiment of the present invention it is provided that the power switching device is additionally designed to enable an electrical energy flow from the electrical energy storage mechanism into the distribution network. This enables a cost-effective operating manner of the device.

According to still another advantageous specific embodiment of the present invention it is provided that the device is suitable for connection to a three-phase service tap line. Thereby the device is also able to be used in the area of electrical energy technology for applications having a high energy requirement. It is possible that one should mount the device in such a way that it is able to switch back and forth between the phases, in order to simulate the presence, as it were, for each current-carrying phase.

According to yet another advantageous specific embodiment of the present invention, it is provided that the electrical energy storage mechanism is developed as a three-phase battery system. This advantageously makes possible simulating the presence of the person for each current-carrying phase.

According to a further advantageous specific embodiment of the present invention, it is provided that, as the electrical energy storage mechanism, an electrical energy storage mechanism be used of a photovoltaic system, an uninterrupted power supply or another electrical system.

According to yet another advantageous specific embodiment of the present invention, it is provided that the change in the current consumption profile of the distribution network for a private sphere protection function for the at least one person is able to be carried out.

According to still another advantageous specific embodiment of the present invention, it is provided that, because of the change in the current consumption profile of the distribution network, a simulation of the presence of the at least one person is able to be carried out.

According to still another advantageous specific embodiment of the present invention, it is provided that the change in the current consumption profile of the distribution network is carried out to simulate the presence of the at least one person.

According to still another advantageous specific embodiment of the present invention, it is provided that the change in the current consumption profile of the distribution network is carried out to provide a private sphere protective function for the at least one person.

The remaining developments and further refinements may be combined as desired if such a combination is useful. Additional possible embodiments, developments and implementations of the present invention also include combinations of features of the present invention not explicitly mentioned above or below with regard to the exemplary embodiments. In particular, in this context, one skilled in the art will also add individual aspects as improvements or supplementations to the respective basic form of the present invention.

### BRIEF DESCRIPTION OF THE DRAWINGS

Additional features and advantages of the present invention are explained below, with reference to the figures.

FIG. 1 shows a schematic representation of a flow chart of a method for changing a current consumption profile of at least one person in a house or a residential unit having a distribution network using a distribution network according to a first specific embodiment of the present invention.

FIG. 2 shows a schematic illustration of a diagram over time of a current consumption profile according to a first specific embodiment of the present invention.

FIG. 3 shows a schematic representation of a device for changing a current consumption profile of at least one person in a house or a residential unit having a distribution network according to a second specific embodiment of the present invention.

### DETAILED DESCRIPTION OF EXAMPLE EMBODIMENTS

Unless indicated otherwise, identical or functionally equivalent elements and devices have been provided with the same reference numerals.

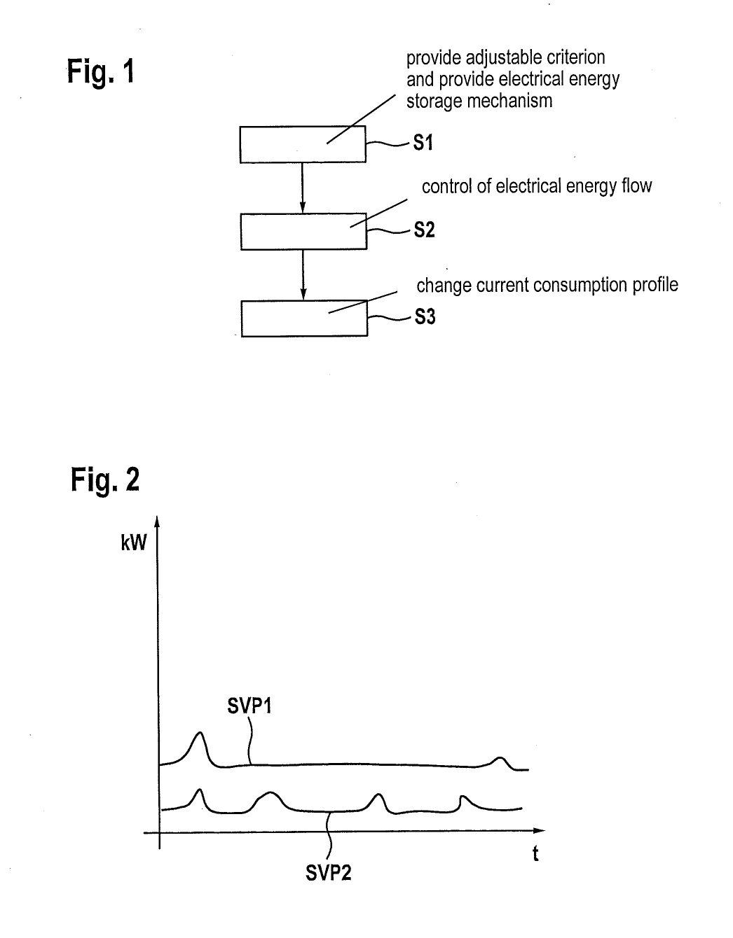

FIG. 1 shows a schematic representation of a flow chart of a method for changing a current consumption profile of at least one person in a house or a residential unit having a distribution network according to a first specific embodiment of the present invention.

One should note that, for three-phase connected households, which mostly also have three current counters, a three-phase controllable battery system is required, in order to be able to simulate the presence of the person for each current-carrying phase. This may also be implemented, if necessary, by a battery having suitable power electronics using three outputs, which are additionally connected to suitable users.

Alternatively to the utilization of a house battery system, it is also possible to use a present electric vehicle or another motor vehicle developed as a plug-in-hybrid electric vehicle, or its battery, to simulate load profiles.

The automatic actuation of users, if present in the system, may also be utilized for the further purposes of comfort, for instance, for the regular, or in certain time periods chance-oriented switching on and off of aquarium and terrarium illuminating systems, for automatic watering of the garden or inside plants, for starting and/or stopping cleaning robots or autonomous lawnmowers or other energy users.

The method for simulating the presence of a person in a house or in a residential unit is carried out by device 100.

In a first method step there is a providing S1 of at least one adjustable criterion for changing current consumption profile SVP1, SVP2 of distribution network 40 by a control device 50 and the providing of an electrical energy storage mechanism 45.

In a second method step there takes place the control S2 of an electrical energy flow with the aid of the at least one variable criterion by the actuation of a power switching device 55 by control device 50, in order to switch on and off the electrical energy flow between electrical energy storage mechanism 45 distribution network 40.

In this context, the electrical energy flow may also be able to be set by different powers, and not only controlled by a rough switching on and off of the users.

In a third method step there takes place a change S3 in current consumption profile SVP1, SVP2 of distribution network 40 to simulate the presence of the person and/or to provide a private sphere protective function.

FIG. 2 shows a schematic representation of a diagram over time of a current consumption profile according to a first specific embodiment of the present invention. The ordinate axis of the diagram over time shown in FIG. 2 represents the electrical power consumption in units of kW, and time t is plotted on the abscissa axis.

A current consumption profile SVP1 is shown in the diagram in FIG. 2, and it reflects the curve over time of the current consumption or energy consumption of a distribution network 40, in the absence of a person. Current consumption profile SVP1, apart from small excursions at the beginning and at the end of the time interval shown, demonstrates a constant profile, from which one may conclude on the presence of the user, the so-called standby consumption (refrigerator, standby functions of stereo system, etc.) being shown in FIG. 2 as a solid line, but in real life a type of “ground noise” comes about because of the standby users, having characteristic peaks.

Deviating from this, in the case of a current consumption profile SVP2, because of the intermittent automatic switching on of a user, a current consumption may be produced which simulates the absence of at least one person.

Current consumption profiles SVP1, SVP2 are recorded, for example, by a current counter integrated in a service tap line 35.

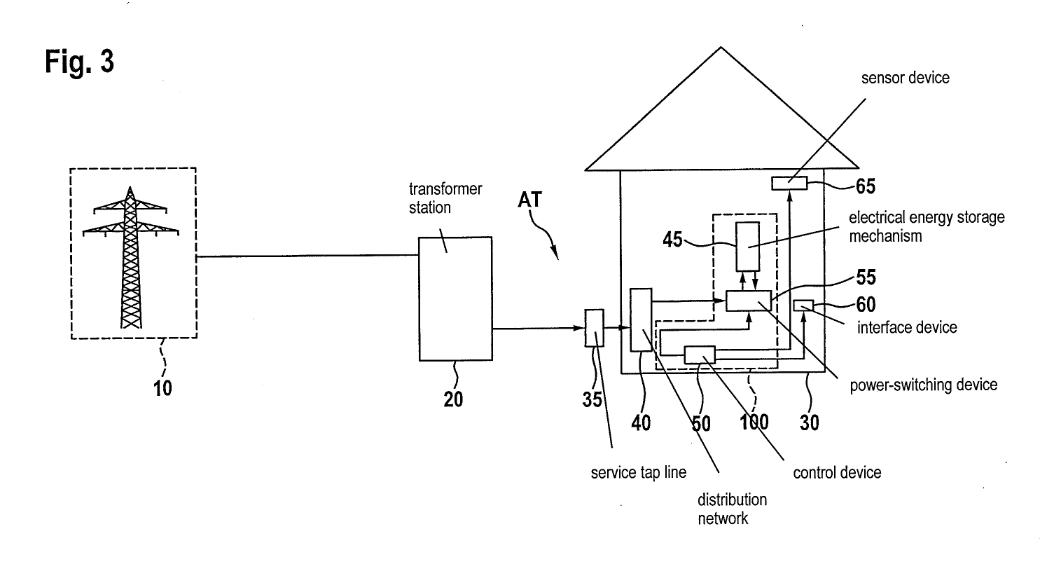

FIG. 3 shows a schematic representation of a device for changing a current consumption profile of at least one person in a house or a residential unit having a distribution network according to a second specific embodiment of the present invention.

A supraregional power network 10 is connected to a transformer station 20, for example. The connection between transformer station 20 and a service tap line 35 is often designated as the last mile. On this last mile, a man-in-the-middle attack AT may now take place, with the aim of finding out whether the inhabitant of the house is present.

Distribution network 40 may be developed, for instance, as a low voltage network and it supplies the respective household.

Supraregional network 10 may take the form of a medium voltage network and/or a transmission network.

Service tap line 35 is connected to distribution network 40 of a house 30, for example.

Device 100 includes an electrical energy storage mechanism 45, a power switching device 55 and a control device 50.

Electrical energy storage mechanism 45 is designed to store electrical energy. The electrical energy storage mechanism 45 is developed, for example, as a battery, a capacitor or a superconductive magnetic energy storage or as a flywheel storage.

Power switching device 55 is connected to electrical energy storage mechanism 45, for example, and distribution network 40, and it is designed to switch on and off an electrical energy flow between electrical energy storage mechanism 45 and distribution network 40.

Control device 50 is designed, for example, for controlling the electrical energy flow with the aid of at least one variable criterion, and thereby to simulate the presence of the person by the change in a current consumption profile SVP1, SVP2 of distribution network 40.

Control device 50 of device 100 may further be connected to a sensor device 65, and may be designed to ascertain the presence of the person based on data recorded by sensor device 65.

Sensor device 65 may be developed as a motion detector or an electronic sensor, for example, which detects motion in its closer surroundings, and is therefore able to function as an electric switch. Sensor device 65 may be used to detect the presence of a person. Sensor device 65 is either able to work actively with electromagnetic waves, using a Doppler radar, with ultrasound using an ultrasonic motion detector, or passively with the aid of infrared radiation of the environment.

Control device 50 of device 100 may also be connected to an interface device 60 and control device 50 may be designed to set the adjustable criteria by inputs actuated from a user via interface device 60. Interface device 60 may be executed as a liquid crystal screen or a liquid crystal display having a touch screen, or as a house computer.

The at least one variable criterion is stated as a control rule for control device 50, for example and includes details on the maximum duration of a constant current consumption in current consumption profiles SVP1, SVP2. For example, the criterion specified as a control rule may also include details on clock times and weekdays at which current consumption profiles SVP1, SVP2 have certain characteristics, such as perhaps increased current consumption on a workday in the morning.

The at least one variable criterion in this instance may be set as a function of the location of use by the manufacturer before the device is installed, and may then continue in use in the state of the factory settings. Furthermore, the at least one variable criterion may also be adjusted by appropriate user inputs, and in addition it is possible to undertake an update of the control algorithms, by encrypted Internet connection or software installation via a data carrier, such as a USB stick, via an optical data carrier or via a flash data memory implemented on a semiconductor crystal having microelectronic memory structures.

Although the present invention was described above with reference to preferred exemplary embodiments, it is not limited to these, but may be modified in many ways. In particular, one is able to change or modify the device in many ways without deviating from the crux of the present invention.

What is claimed is:

1. A device for changing a current consumption profile of at least one person in a house or in a residential unit having a distribution network, the device comprising:
an electrical energy storage mechanism which is designed to store electrical energy;
a power switching device connected to the electrical energy storage mechanism and the distribution network and designed to switch on and off an electrical energy flow between the electrical energy storage mechanism and the distribution network; and
a control device designed to control the electrical energy flow with the aid of at least one variable criterion, and thereby to change the current consumption profile of the distribution network.

2. The device as recited in claim 1, wherein the control device of the device is further connected to an interface device and is designed to set the at least one variable criterion by inputs of a user that are actuated via the interface device.

3. The device as recited in claim 2, wherein the control device is further designed to display to the user via the interface device at least one of: i) data on an operating state of the device, and ii) data on currently occurring electrical energy flow.

4. The device as recited in claim 1, wherein the control device of the device is further connected to a sensor device and is designed to ascertain the presence of the person based on data recorded by the sensor device.

5. The device as recited in claim 1, wherein the device is further connected to additional consumers of the distribution network to discharge the electrical energy storage mechanism.

6. The device as recited in claim 1, wherein the power switching device is further designed to enable an electrical energy flow from the electrical energy storage mechanism into the distribution network.

7. The device as recited in claim 1, wherein the device is suitable for being connected to a three-phase service tap line.

8. The device as recited in claim 7, wherein the electrical energy storage mechanism is developed as a three-phase battery system.

9. The device as recited in claim 1, wherein, as the electrical energy storage mechanism, an electrical energy storage mechanism of one of a photovoltaic system, or an uninterrupted power supply is used.

10. The device as recited in claim 1, wherein by changing the current consumption profile of the distribution network a private sphere protective function for the at least one person is carried out.

11. The device as recited in claim 1, wherein by changing the current consumption profile of the distribution network, a simulation is carried out in a presence of the at least one person.

12. A method for changing a current consumption profile of at least one person in a house or in a residential unit having a distribution network, comprising:
providing of at least one variable criterion for changing the current consumption profile of the distribution network by a control device and providing an electrical energy storage mechanism;
controlling an electrical energy flow with at least one variable criterion by actuating a power switching device by the control device to switch on and off electrical energy flow between electrical energy storage mechanism and the distribution network; and
changing the current consumption profile of the distribution network.

13. The method as recited in claim 12, wherein the changing of the current consumption profile of the distribution network is undertaken to simulate presence of the at least one person.

14. The method as recited in claim 12, wherein the changing of the current consumption profile of the distribution network is undertaken to provide a private sphere protective function for the at least one person.
